(19) United States
(12) Patent Application Publication
(10) Pub. No.: US 2025/0007008 A1
(43) Pub. Date: Jan. 2, 2025

(54) ELECTRODE FOR SOLID-STATE BATTERY, AND SOLID-STATE BATTERY

(71) Applicants: TOYOTA JIDOSHA KABUSHIKI KAISHA, Toyota-shi Aichi-ken (JP); Panasonic Holdings Corporation, Kadoma-shi Osaka (JP)

(72) Inventors: Akio MITSUI, Anjyo-shi Aichi-ken (JP); Hiroo NOZAKI, Chiryu-shi Aichi-ken (JP); Kenji NAGAO, Toyota-shi Aichi-ken (JP)

(73) Assignees: TOYOTA JIDOSHA KABUSHIKI KAISHA, Toyota-shi Aichi-ken (JP); Panasonic Holdings Corporation, Kadoma-shi Osaka (JP)

(21) Appl. No.: 18/748,705

(22) Filed: Jun. 20, 2024

(30) Foreign Application Priority Data
Jun. 30, 2023 (JP) 2023-108759

(51) Int. Cl. H01M 10/42; H01M 10/0562

(52) U.S. Cl. CPC H01M 10/4235; H01M 10/0562; H01M 2300/008

(57) ABSTRACT

An electrode for a solid-state battery includes a sulfide solid electrolyte, and a metal that reacts with the sulfide solid electrolyte to exhibit electron conductivity. The content of the metal, with respect to the total volume of the electrode for a solid-state battery, is greater than or equal to 5 ppm by volume and less than 10,000 ppm by volume.

### CROSS-REFERENCE TO RELATED APPLICATION

This application is based on and claims priority under 35 USC 119 from Japanese Patent Application No. 2023-108759, filed on Jun. 30, 2023, the disclosure of which is incorporated by reference herein.

### BACKGROUND

### Technical Field

The present disclosure relates to an electrode for a solid-state battery, and to a solid-state battery.

### Related Art

Accompanying the rapid popularization of information-related devices, communication devices and the like such as personal computers, video cameras, and cell phones in recent years, the development of batteries that are used as the power sources thereof is regarded as important. Thereamong, attention is focusing on lithium ion batteries from the standpoints that such batteries have high energy density and stability.

Conventionally, electrolytic liquids containing flammable organic solvents are used in batteries that are used in the foregoing applications. Therefore, there is the need for improvement in structures and materials for preventing short-circuiting and for mounting safety devices that suppress a rise in temperature at the time of short-circuiting. To address this, batteries in which the electrolytic solution is replaced by a solid electrolyte layer are being developed. This is because, as a result of making the battery be a solid-state battery through use of a solid electrolyte instead of an electrolytic solution, a flammable organic solvent is not used within the battery, safety devices can be simplified, and the manufacturing cost and production efficiency are improved.

Usually, in a case in which the positive electrode layer and the negative electrode layer of a solid-state battery contain a metal such as copper, the metal is removed because there is the concern that short-circuiting will be brought about.

For example, in Japanese Patent Application Laid-Open (JP-A) No. 2020-191183, a solid-state battery having a positive electrode layer, a sulfide solid electrolyte layer and a negative electrode layer is aged before the initial charging, and the metal such as copper is thereby removed through melting.

### SUMMARY

Solid-state batteries have the tendency that the resistance thereof increases due to repeated charging and discharging cycles. The increase in the resistance means that the deterioration of the battery due to charging and discharging of the battery increases.

The present inventors have found that the above-described increase in resistance can be curbed by including a specific metal at a specific content in the positive electrode layer or the negative electrode layer.

An embodiment according to the present disclosure has been made in view of the above-described circumstances, and directed to the provision of an electrode for a solid-state battery and a solid-state battery in which an increase in the resistance of a solid-state battery can be reduced.

Aspects according to the present disclosure for providing such an electrode and a solid-state battery include the following aspects.

<1> An electrode for a solid-state battery, including:
a sulfide solid electrolyte; and
a metal that reacts with the sulfide solid electrolyte to exhibit electron conductivity,
wherein the content of the metal, with respect to the total volume of the electrode for a solid-state battery, is greater than or equal to 5 ppm by volume and less than 10,000 ppm by volume.
   <2> The electrode for a solid-state battery according to <1>, wherein the metal is at least one metal selected from the group consisting of copper, silver, nickel, iron, tin, aluminum, titanium, chromium, zinc, gold, magnesium, antimony, zirconium, molybdenum, and alloys thereof.
   <3> The electrode for a solid-state battery according to <2>, wherein the metal is at least one of copper or silver.
   <4> The electrode for a solid-state battery according to any one of <1> to <3>, wherein the content of the metal, with respect to the total volume of the electrode for a solid-state battery, is greater than or equal to 50 ppm by volume.
   <5> The electrode for a solid-state battery according to any one of <1> to <4>, wherein the content of the metal, with respect to the total volume of the electrode for a solid-state battery, is less than or equal to 5,000 ppm by volume.
   <6> The electrode for a solid-state battery according to any one of <1> to <5>, wherein the sulfide solid electrolyte contains a phosphorus atom.
   <7> A solid-state battery, including a positive electrode layer, a solid electrolyte layer, and a negative electrode layer,
wherein at least one of the positive electrode layer or the negative electrode layer is the electrode for a solid-state battery according to any one of <1> to <6>.

In accordance with an embodiment according to the present disclosure, there can be provided an electrode for a solid-state battery and a solid-state battery in which an increase in the resistance of a solid-state battery can be reduced.

### BRIEF DESCRIPTION OF THE DRAWINGS

FIG. 1 is a schematic cross-sectional view illustrating an embodiment of a solid electrolyte according to the present disclosure.

### DETAILED DESCRIPTION

In the present disclosure, any numerical range expressed using “to” means a range including numerical values described before and after “to” as the lower limit value and the upper limit value.

For numerical ranges described in a stepwise manner in the present disclosure, the upper limit value or the lower limit value of one numerical range may be replaced with the upper limit value or the lower limit value of another numerical range in the stepwise description. The upper limit value or the lower limit value of any numerical range described in the present disclosure may also be replaced with a value described in an Example.

In the present disclosure, a combination of two or more aspects constitutes another aspect.

In a case in which plural substances corresponding to a component of interest are present, the amount of the component described in the present specification means the total amount of the plural substances, unless otherwise specified.

In the present disclosure, “solid electrolyte” means an electrolyte that maintains a solid state at 25° C. in the nitrogen atmosphere.

In the present disclosure, the scope of “sulfide solid electrolyte” includes both crystalline sulfide solid electrolytes having a crystal structure and amorphous sulfide solid electrolytes.

In the present disclosure, a crystalline sulfide solid electrolyte is a solid electrolyte of which X-ray diffraction pattern obtained by powder X-ray diffraction (XRD) measurement exhibits a peak derived from the solid electrolyte, no matter whether or not a peak derived from the raw material of the solid electrolyte is present in the X-ray diffraction pattern. Namely, a crystalline sulfide solid electrolyte is a sulfide solid electrolyte that includes a crystal structure derived from the solid electrolyte, and in which a portion of the sulfide solid electrolyte or the entire sulfide solid electrolyte may be the crystal structure derived from the solid electrolyte. Further, the crystalline sulfide solid electrolyte may contain an amorphous sulfide solid electrolyte (also called a “glass component”) at a portion thereof, as long as the crystalline sulfide solid electrolyte has an X-ray diffraction pattern as described above. Accordingly, the scope of crystalline sulfide solid electrolytes includes a so-called glass ceramic that is obtained by heating an amorphous solid electrolyte (a glass component) to the crystallization temperature thereof or higher.

Further, in the present disclosure, the amorphous sulfide solid electrolyte (glass component) is a sulfide solid electrolyte of which X-ray diffraction pattern obtained by powder X-ray diffraction (XRD) measurement exhibits a halo pattern, in which substantially no peaks other than material-derived peaks are observed, regardless of whether or not peaks derived from raw materials of the solid electrolyte are present.

### [Electrode for Solid-State Battery]

The electrode for a solid-state battery according to the present disclosure contains a sulfide solid electrolyte, and a metal that reacts with the sulfide solid electrolyte to exhibit electron conductivity (hereinafter also called the “specific metal”).

The content of the metal with respect to the total volume of the electrode for a solid-state battery is greater than or equal to 5 ppm by volume, and less than 10,000 ppm by volume.

In accordance with the electrode for a solid-state battery according to the present disclosure, an increase in the resistance of a solid-state battery can be reduced. Although the reason why this effect is exhibited is not clear, it is assumed to be as follows.

Since the electrode for a solid-state battery according to the present disclosure contains a sulfide solid electrolyte and greater than or equal to 5 ppm by volume of the specific metal, when heat is generated during charging and discharging, the sulfide solid electrolyte and the specific metal react to generate a metal sulfide or a metal thiophosphate. We surmise that electron conductivity of these generated substances improves the electron conducting path efficiency and curbs an increase in resistance. Further, we surmise that the reaction between the sulfide solid electrolyte and the specific metal imparts electron conductivity to the sulfide solid electrolyte, and reduces an increase in resistance.

Moreover, we also surmise that adjusting the content of the specific metal in the electrode for a solid-state battery according to the present disclosure to be less than 10,000 ppm by volume enables a decrease in the ion conductivity to be curbed, and curbs an increase in resistance.

The reduction in the increase in the resistance of a solid-state battery can also be evaluated based on the resistance of the solid-state battery after heat-treatment, as indicated in the Examples described later.

### (Sulfide Solid Electrolyte)

The sulfide solid electrolyte may contain a lithium atom, a sulfur atom and a halogen atom.

In some embodiments, from the standpoint of causing the sulfide solid electrolyte and the specific metal to react and even more curbing an increase in resistance, the sulfide solid electrolyte contains a phosphorus atom. Due to a phosphorus atom being included in the sulfide solid electrolyte, a metal thiophosphate is generated, and both ion conductivity and electron conductivity can be exhibited.

The sulfide solid electrolyte may be amorphous or may be crystalline.

In one embodiment, the composition of the sulfide solid electrolyte is represented by, for example, xLi₂S·(100-x)P₂S₅(70≤x≤80), or yLiI·zLiBr·(100-y-z)(xLi₂S·(1-x)P₂S₅) (0.7≤x≤0.8, 0≤y≤30, 0≤z≤30).

Further, the sulfide solid electrolyte may have the composition represented by following Formula (1).

$${Li}_{4 - x} {Ge}_{1 - x} {P}_{x} {S}_{4} ( 0 < x < 1 ) \qquad Formula ( 1 )$$

In Formula (1), at least a portion of the Ge may be replaced by at least one selected from the group consisting of Sb, Si, Sn, B, Al, Ga, In, Ti, Zr, V and Nb. Further, at least a portion of the P may be replaced by at least one selected from the group consisting of Sb, Si, Sn, B, Al, Ga, In, Ti, Zr, V and Nb. A portion of the Li may be replaced by at least one selected from the group consisting of Na, K, Mg, Ca and Zn. A portion of the S may be replaced by a halogen, and the halogen may be at least one of F, Cl, Br or I.

Examples of amorphous sulfide solid electrolytes include: solid electrolytes structured from lithium sulfide, phosphorus sulfide, and lithium halides such as Li₂S—P₂S₅—LiI, Li₂S—P₂S₅—LiCl, Li₂S—P₂S₅—LiBr, and Li₂S—P₂S₅—LiI—LiBr; solid electrolytes further containing another atom such as an oxygen atom or a silicon atom such as Li₂S—P₂S₅—Li₂O—LiI and Li₂S—SiS₂—P₂S₅—LiI.

In some embodiments, from the standpoint of obtaining even higher ion conductivity, examples include solid electrolytes structured from lithium sulfide, phosphorus sulfide and lithium halides such as Li₂S—P₂S₅—LiI, Li₂S—P₂S₅—LiCl, Li₂S—P₂S₅—LiBr, and Li₂S—P₂S₅—LiI—LiBr.

The types of the atoms that structure the amorphous sulfide solid electrolyte can be confirmed by, for example, an ICP emission spectrophotometer.

The crystalline sulfide solid electrolyte may be a so-called glass ceramic that is obtained by heating an amorphous solid electrolyte to the crystallization temperature or higher. Examples of the crystal structure thereof include Li₃PS₄ crystal structure, Li₄P₂S₆ crystal structure, Li₇PS₆ crystal structure, Li₇P₃S₁i crystal structure, and crystal structures having peaks in the vicinity of 20=20.2° and in the vicinity of 23.6° (see, for example, JP-A No. 2013-16423). Further examples include Li₄₋ₓGe₁₋ₓPₓS₄-type thio-LISICON Region II type crystal structures (refer to Kanno et al., Journal of The Electrochemical Society, 148(7) A742-746 (2001)), and crystal structures (refer to Solid State Ionics, 177(2006), 2721-2725) that are similar to Li₄₋ₓGe₁₋ₓPₓS₄-type thio-LISICON Region II type crystal structures.

The form of the sulfide solid electrolyte is not particularly limited, and the sulfide solid electrolyte is, for example, particulate. The average particle diameter (D₅₀) of particulate sulfide solid electrolyte is within a range of, for example, from 0.01 m to 500 m, or from 0.1 to 200 km.

In some embodiments, the content of the sulfide solid electrolyte with respect to the total mass of the electrode for a solid-state battery is from 2 mass % to 90 mass %, or from 5 mass % to 30 mass %.

In some embodiments, the content (volume ratio) of the sulfide solid electrolyte with respect to the total volume of the electrode for a solid-state battery is from 3 vol % to 95 vol % or from 4 vol % to 85 vol %.

### (Specific Metal)

The electrode for a solid-state battery according to the present disclosure contains a metal that reacts with a sulfide solid electrolyte to exhibit electron conductivity (i.e., the specific metal). Examples of the specific metal include at least one metal selected from the group consisting of copper, silver, nickel, iron, tin, aluminum, titanium, chromium, zinc, gold, magnesium, antimony, zirconium, molybdenum, and alloys thereof. In some embodiments, from the standpoint of reducing an increase in resistance even more, at least one of copper or silver is selected or and copper is selected.

The form of the metal is not particularly limited, and the metal may be particulate or non-particulate.

Here, description is given of a method of verifying whether or not a metal is a metal that reacts with a sulfide solid electrolyte to exhibit electron conductivity (i.e., is the specific metal). First, the metal to be examined and a sulfide solid electrolyte are mixed together and heat-treatment, to obtain a sample. The mixing conditions and the heat treatment conditions as described below are adopted.

Mixing Conditions: A sulfide solid electrolyte and the metal to be examined (a metal powder is used therefor) are mixed together such that the volume concentration of the metal powder is 5%. 1 g of the sulfide solid electrolyte and the metal powder in an amount to provide a volume concentration of 5% are weight out, and dry blended sufficiently for 5 minutes using a mortar, to obtain a mixed powder.

Heat Treatment Conditions: The below-described Swagelok cell is placed in a thermostatic tank that is set to 150° C., and heat-treated for seven days. After the seven days, the Swagelok cell is taken out of the thermostatic tank. After the Swagelok cell is cooled to 25° C., the electron conductance after the heat treatment is measured.

With respect to the obtained sample, electron conductance before the heat treatment and electron conductance after the heat treatment are measured by the following method.

200 mg of the sample is weighed out, is placed in a cylinder manufactured by Swagelok, and is pressed at a pressure of 1 ton/cm². Both ends of the pellet thus obtained are nipped by SUS pins, and a restraining pressure is applied to the pellet by fastening the bolts. This structure in which the pellet is enclosed in the cylinder manufactured by Swagelok is called a Swagelok cell. For obtaining the sample after heat treatment, this Swagelok cell is subjected to heat treatment under the above-described heat treatment conditions. The electron conductance is determined by the direct current polarization method in a state in which the obtained sample is maintained at 25° C. CELTEST and SOLARTRON 1260 manufactured by Solartron are used for the measurement. A voltage of 0.1 V, 0.2 V or 0.3 V is applied for 30 seconds, and the flowing current amount at each voltage is measured. The resistance is calculated from the relationship between the applied voltage and the flowing current amount, and the electron conductance is calculated therefrom.

Thereafter, the electron conductances before and after the heat treatment are compared. The rate of increase in the electron conductance is calculated by dividing the electron conductance after the heat treatment by the electron conductance before the heat treatment. If the rate of increase in the electron conductance is greater than or equal to 2.17, it is judged that the metal is a metal that reacts with the sulfide solid electrolyte to exhibit electron conductivity (i.e., is the specific metal).

In some embodiments, when the specific metal is particulate, a smaller particle diameter is desirable because the reactivity with the sulfide solid electrolyte increases, which enables a greater effect to be exhibited.

In some embodiments, from the standpoint of allowing the sulfide solid electrolyte and the specific metal to react and reducing an increase in resistance even more, the content of the specific metal with respect to the total volume of the electrode for a solid-state battery is greater than or equal to 20 ppm by volume, greater than or equal to 100 ppm by volume, greater than or equal to 200 ppm by volume, greater than or equal to 450 ppm by volume, greater than or equal to 600 ppm by volume, or may be greater than or equal to 1,000 ppm by volume.

In some embodiments, from the standpoint of curbing a decrease in ion conductivity and reducing an increase in resistance even more, the content of the specific metal with respect to the total volume of the electrode for a solid-state battery is less than or equal to 8,000 ppm by volume, less than or equal to 7,000 ppm by volume, less than or equal to 6,000 ppm by volume, less than or equal to 5,500 ppm by volume, or may be less than or equal to 5,000 ppm by volume.

In some embodiments, from the standpoint of making the self-discharge amount small and reducing short-circuiting, the content of the specific metal with respect to the total volume of the electrode for a solid-state battery is less than or equal to 4,000 ppm by volume, or less than or equal to 3,000 ppm by volume.

In the present disclosure, the content (volume ratio) of the specific metal in the electrode for a solid-state battery can be measured by the following method.

A cross-section of the electrode for a solid-state battery is observed by a scanning electron microscope with EDS (SEM-EDS, magnification 30,000X), and the content (the volume ratio) of the specific metal can be measured by carrying out element analysis by energy dispersive spectroscopy (EDS).

### (Active Material)

The electrode for a solid-state battery according to the present disclosure may contain an active material. The active material may be a positive electrode active material, or may be a negative electrode active material.

In some embodiments, the electrode for a solid-state battery according to the present disclosure contains a lithium composite oxide as a positive electrode active material. The lithium composite oxide may include at least one selected from the group consisting of F, Cl, N, S, Br and I. Further, the lithium composite oxide may have a crystal structure belonging to at least one space group selected from space groups R-3m, Immm, and P63-mmc (also called P63mc, P6/mmc). In the lithium composite oxide, the main sequence of a transition metal, oxygen and lithium may be an O2-type structure.

Examples of lithium composite oxides having a crystal structure belonging to R-3m include compounds represented by LiₓMe_{y}OᵤX_{β} (in which Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si and P, and X represents at least one selected from the group consisting of F, Cl, N, S, Br and I, and x, y, a, and R satisfy 0.5<x<1.5, 0.5<y<1.0, 1<a<2, and 0<β≤1).

Examples of lithium composite oxides having a crystal structure belonging to Immm include composite oxides represented by Liₓ₁M¹A¹₂(in which x1 satisfies 1.5<x1<2.3, M¹ includes at least one selected from the group consisting of Ni, Co, Mn, Cu and Fe, A¹ includes at least oxygen, and the proportion of oxygen in the entire A¹ is greater than or equal to 85 atom %) (a specific example of which is Li₂NiO₂), and composite oxides represented by Liₓ₁M^{1A}₁₋ₓ₂M^{1B}ₓ₂O_{2-y}A²_{y} (in which x2 satisfies 0≤x2≤0.5, y satisfies 0≤y≤0.3, at least one of x2 or y is not 0, M^{IA} represents at least one selected from the group consisting of Ni, Co, Mn, Cu and Fe, M^{1B} represents at least one selected from the group consisting of Al, Mg, Sc, Ti, Cr, V, Zn, Ga, Zr, Mo, Nb, Ta and W, and A2 represents at least one selected from the group consisting of F, Cl, Br, S and P).

Examples of lithium composite oxides having a crystal structure belonging to P63-mmc include composite oxides represented by M1ₓM2_{y}O₂ (in which M1 represents an alkali metal (at least one of Na or K is selected), M2 represents a transition metal (at least one selected from the group consisting of Mn, Ni, Co and Fe is selected), and x+y satisfies 0<x+y<2).

Examples of lithium composite oxides having an O2-type structure include composite oxides represented by Liₓ[Li_{α}(MnₐCo_{b}M_{c})_{1-α}]O₂ (x satisfies 0.5<x<1.1, α satisfies 0.1<α<0.33, a satisfies 0.17<a<0.93, b satisfies 0.03<b<0.50, c satisfies 0.04<c<0.33, and M represents at least one selected from the group consisting of Ni, Mg, Ti, Fe, Sn, Zr, Nb, Mo, W and Bi). Specific examples thereof include Li_{0.744}[Li_{0.145}Mn_{0.625}Co_{0.115}Ni_{0.115}]O₂.

Examples of negative electrode active materials include silicon, silicon alloys, and silicon oxides. Further, examples of negative electrode active materials that can be used include metallic lithium and metals that can form alloys with metallic lithium, such as metallic lithium, metallic indium, metallic aluminum, metallic silicon, and metallic tin, and oxides of these metals, and alloys of these metals with metallic lithium. Examples of oxides include oxide active materials such as Li₄Ti₅O₁₂. Examples of negative electrode active materials also include carbon. Examples of the carbon include natural graphite, artificial graphite, hard carbon (non-graphitizing carbon), and soft carbon (easily graphitizable carbon). Examples of artificial graphite include highly oriented graphite and mesocarbon microbeads.

In some embodiments, the content of the active material in the positive electrode in the electrode for a solid-state battery according to the present disclosure is from 20 mass % to 99 mass %, or from 50 mass % to 90 mass %, with respect to the total mass of the positive electrode. In some embodiments, the content of the active material in the negative electrode in the electrode for a solid-state battery according to the present disclosure is from 20 mass % to 99 mass %, or from 50 mass % to 90 mass %, with respect to the total mass of the negative electrode. However, with regard to the negative electrode, the content of the active material may be 100 mass % in a case in which an Li metal or the like is used.

In some embodiments, the content (volume ratio) of the active material in the positive electrode is from 10 vol % to 99 vol %, or from 32 vol % to 81 vol %, with respect to the total volume of the positive electrode. In some embodiments, the content (volume ratio) of the active material in the negative electrode is from 10 vol % to 99 vol %, or from 32 vol % to 81 vol %, with respect to the total volume of the negative electrode.

### (Conductive Aid)

The electrode for a solid-state battery according to the present disclosure may contain a conductive aid.

Examples of the conductive aid include carbon-based materials such as artificial graphite, graphite carbon fibers, resin baked carbon, thermally decomposed vapor-grown carbon, coke, mesocarbon microbeads, furfuryl alcohol resin baked carbon, polyacene, pitch-based carbon fibers, vapor-grown carbon fibers, natural graphite, and non-graphitizing carbon.

In some embodiments, the content of the conductive aid in the positive electrode in the electrode for a solid-state battery according to the present disclosure is from 0 mass % to 20 mass %, or from 0 mass % to 3 mass %, with respect to the total mass of the positive electrode. In some embodiments, the content of the conductive aid in the negative electrode in the electrode for a solid-state battery according to the present disclosure is from 0 mass % to 20 mass %, or from 0 mass % to 3 mass %, with respect to the total mass of the negative electrode.

In some embodiments, the content (volume ratio) of the conductive aid in the positive electrode is from 0 vol % to 45 vol %, or from 0 vol % to 5.5 vol %, with respect to the total volume of the positive electrode. In some embodiments, the content (volume ratio) of the conductive aid in the negative electrode is from 0 vol % to 45 vol %, or from 0 vol % to 5.5 vol %, with respect to the total volume of the negative electrode.

### (Binder)

The electrode for a solid-state battery according to the present disclosure may contain a binder.

Examples of the binder include fluorine-based polymers such as polytetrafluoroethylene and polyvinylidene fluoride, thermoplastic elastomers such as butylene rubber and styrene-butadiene rubber, and various resins such as acrylic resins, acrylic polyol resins, polyvinyl acetal resins, polyvinyl butyral resins, and silicone resins.

In some embodiments, the content of the binder in the positive electrode in the electrode for a solid-state battery according to the present disclosure is from 0 mass % to 10 mass %, or from 0 mass % to 3 mass %, with respect to the total mass of the positive electrode. In some embodiments, the content of the binder in the negative electrode in the electrode for a solid-state battery according to the present disclosure is from 0 mass % to 10 mass %, or from 0 mass % to 3 mass %, with respect to the total mass of the negative electrode.

In some embodiments, the content (volume ratio) of the binder in the positive electrode is 0 vol % to 42.5 vol %, or 0 vol % to 12 vol %, with respect to the total volume of the positive electrode. In some embodiments, the content (volume ratio) of the binder in the negative electrode is 0 vol % to 42.5 vol %, or 0 vol % to 12 vol %, with respect to the total volume of the negative electrode.

### (Other Components)

The electrode for a solid-state battery according to the present disclosure may contain components (hereinafter called “other components”) other than the above-described components. Examples of the other components include solid electrolytes other than sulfide solid electrolytes. Examples of solid electrolytes other than sulfide solid electrolytes include oxide solid electrolytes and halide solid electrolytes.

In some embodiments, the oxide solid electrolyte contains oxygen (O) as the main anion element, and, for example, may contain Li, element Q (Q representing at least one of Nb, B, Al, Si, P, Ti, Zr, Mo, W or S), and O. Examples of the oxide solid electrolyte include garnet type solid electrolytes, perovskite type solid electrolytes, NASICON type solid electrolytes, Li—P—O type solid electrolytes, and Li—B—O type solid electrolytes. Examples of garnet type solid electrolytes include Li₇La₃Zr₂O₁₂, Li₇₋ₓLa₃(Zr₂₋ₓNbₓ)O₁₂ (0<x<2), and Li₅La₃Nb₂O₁₂. Examples of perovskite type solid electrolytes include (Li, La)TiO₃, (Li, La)NbO₃, and (Li, Sr)(Ta, Zr)O₃. Examples of NASICON type solid electrolytes include Li(Al, Ti)(PO₄)₃, and Li(Al, Ga)(PO₄)₃. Examples of Li—P—O type solid electrolytes include Li₃PO₄ and UPON (compounds in which part of O's in Li₃PO₄ is replaced by N). Examples of Li—B—O type solid electrolytes include Li₃BO₃, and compounds in which part of O's in Li₃BO₃ is replaced by C.

As the halide solid electrolyte, a solid electrolyte containing Li, M and X (M representing at least one of Ti, Al or Y, and X representing F, Cl or Br) is suitable. In some embodiments, Li_{6-3z}Y_{z}X₆ (in which X represents Cl or Br, and z satisfies 0<z<2) and Li_{6-(4-x)b}(Ti₁₋ₓAlₓ)_{b}F₆ (0<x<1, 0<b≤1.5) are selected. In some embodiments, among Li_{6-3z}Y_{z}X₆, from the standpoint of having lithium ion conductivity, Li₃YX₆ (X representing Cl or Br) is selected, and Li₃YCl₆ may be selected. In some embodiments, from standpoints such as, for example, reducing oxidative decomposition of the sulfide solid electrolyte, Li_{6-(4-x)b}(Ti₁₋ₓAlₓ)_{b}F₆ (0<x<1, 0<b≤1.5) may be contained together with a solid electrolyte such as a sulfide solid electrolyte, and that Li_{6-(4-x)b}(Ti₁₋ₓAlₓ)_{b}F₆ (0<x<1, 0<b≤1.5) may cover at least a portion of the surface of a solid electrolyte such as a sulfide solid electrolyte. This configuration provides a more improved lithium ion conductivity.

### (Applications)

The electrode for a solid-state battery according to the present disclosure can be suitably used as a material that structures the positive electrode or the negative electrode of a solid-state battery.

### [Solid-State Battery]

A solid-state battery according to the present disclosure includes a positive electrode layer, a solid electrolyte layer, and a negative electrode layer, and at least one of the positive electrode layer or the negative electrode layer is the electrode for a solid-state battery according to the present disclosure.

The solid-state battery according to the present disclosure may include a positive electrode current collector at a side of the positive electrode layer that is opposite to the solid electrolyte layer side.

The solid-state battery according to the present disclosure may have a negative electrode current collector at a side of the negative electrode layer that is opposite to the solid electrolyte layer side.

### (Positive Electrode Layer and Negative Electrode Layer)

At least one of the positive electrode layer or the negative electrode layer of the solid-state battery according to the present disclosure is the electrode for a solid-state battery according to the present disclosure.

The structure of an electrode for a solid-state battery, which is other than the electrode for a solid-state battery according to the present disclosure, is not particularly limited, and may be a conventional known structure. Examples of the other electrode include an electrode having the structure described for the electrode for a solid-state battery according to the present disclosure except that the specific metal is not contained.

Since the electrode for a solid-state battery according to the present disclosure is described above, description thereof is omitted here.

The thickness of the positive electrode layer is not particularly limited, and may be, for example, greater than or equal to 1 nm and less than or equal to 500 m.

The thickness of the negative electrode layer is not particularly limited, and may be, for example, greater than or equal to 1 nm and less than or equal to 500 m.

### (Solid Electrolyte Layer)

The solid electrolyte layer may include a solid electrolyte. The solid electrolyte layer may have a single-layer structure, or may have a multilayer structure having two or more layers. The solid electrolyte to be used may be any of conventional known solid electrolytes that can be used in a solid electrolyte layer of a solid-state battery, examples of which include sulfide solid electrolytes.

The solid electrolyte layer may contain a binder. Examples of the binder include rubber-based binders such as styrene-butadiene rubber, and fluorinated binders such as polyvinylidene fluoride (PVDF).

The thickness of the solid electrolyte layer is not particularly limited, and the thickness is, for example, greater than or equal to 1 nm and less than or equal to 500 m.

### (Positive Electrode Current Collector)

The positive electrode current collector to be used may be a conventional known positive electrode current collector. In some embodiments, examples of the positive electrode current collector include stainless steel, aluminum, nickel, iron, titanium, and carbon, and an aluminum alloy foil or an aluminum foil is selected. The aluminum alloy foil and the aluminum foil may be manufactured using a powder. The form of the positive electrode current collector is, for example, a foil form or a mesh form.

The thickness of the positive electrode current collector is not particularly limited, and the thickness is, for example, greater than or equal to 1 nm and less than or equal to 50 m.

### (Negative Electrode Current Collector)

Any of the above-described metal foils may be used as the negative electrode current collector. In some embodiments, a nickel foil and an aluminum foil are selected.

The thickness of the negative electrode current collector is not particularly limited, and the thickness is, for example, greater than or equal to 1 nm and less than or equal to 50 m.

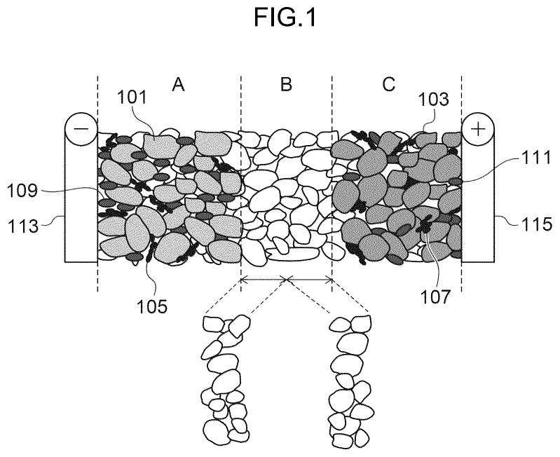

A schematic cross-sectional view illustrating an embodiment of the solid-state battery according to the present disclosure is presented in FIG. 1. As illustrated in FIG. 1, a negative electrode layer A, a solid electrolyte layer B and a positive electrode layer C are layered.

In FIG. 1, a negative electrode active material is denoted by reference numeral 101, a positive electrode active material is denoted by reference numeral 103, conductive aids are denoted by reference numerals 105 and 107, binders are denoted by reference numerals 109 and 111, a negative electrode current collector is denoted by reference numeral 113, and a positive electrode current collector is denoted by reference numeral 115.

At least one of the negative electrode layer A or the positive electrode layer C contains the specific metal (not illustrated).

The solid-state battery may have a structure in which the layer-stack edge faces (side faces) of the layered structure of the positive electrode/the solid electrolyte layer/the negative electrode are sealed by a resin. Each of the positive electrode current collector and the negative electrode current collector may have a structure in which a shock-absorbing layer, an elastic layer or a PTC (Positive Temperature Coefficient) thermistor layer is disposed on the surface of the current collector.

Further, the solid electrolyte layer may have a two-layer structure as illustrated in FIG. 1.

An embodiment of a method used for producing the solid-state battery according to the present disclosure is described below, but the method is not limited thereto.

First, a positive electrode mix paste that includes a sulfide solid electrolyte, the specific metal, a positive electrode active material, a conductive aid, a binder and the like dissolved or dispersed in a given solvent is coated on a positive electrode current collector, and is dried to form a positive electrode layer. A positive electrode sheet that includes the positive electrode current collector and the positive electrode layer is prepared thereby.

Next, a negative electrode mix paste that includes a sulfide solid electrolyte, the specific metal, a negative electrode active material, a conductive aid, a binder and the like dissolved or dispersed in a given solvent is coated on a face of a negative electrode current collector, and is dried to form a negative electrode layer. A negative electrode sheet that includes the negative electrode current collector and the negative electrode layer is prepared thereby.

Next, a paste for a solid electrolyte layer that includes a solid electrolyte, a binder and the like dissolved or dispersed in a given solvent is coated on a metal foil such as an aluminum foil or an SUS foil, and is dried to form a solid electrolyte layer. A solid electrolyte sheet that includes the metal foil and the solid electrolyte layer is prepared thereby.

Next, the negative electrode sheet and the solid electrolyte sheet are layered one on the other, and pressed, thereby transferring the solid electrolyte layer onto the surface of the negative electrode layer.

Next, the positive electrode sheet is layered on a side of the solid electrolyte layer that is opposite to the negative electrode layer side, and is pressed, as a result of which the solid-state battery can be produced.

The solid-state battery produced by the above-described method includes the positive electrode current collector, the positive electrode layer, the solid electrolyte layer, the negative electrode layer and the negative electrode current collector in this order.

Examples of the aforementioned solvents include water, N-methyl-2-pyrrolidone, butyl butyrate, tetrahydronaphthalene, heptane, dibutyl ether, and diisobutyl ketone (DIBK).

### EXAMPLES

The present disclosure is described in more detail hereinafter by way of Examples, but the present disclosure is not limited to these Examples.

### Examples 1 to 7

LiNi_{0.8}(CoAl)_{0.2}O₂ as the positive electrode active material was provided, which had been subjected to LTAF (Li—Ti—Al—F) surface treatment.

The positive electrode active material, conductive carbon, a solid electrolyte (Li₂S—P₂S₅—LiBr—LiI-based glass ceramic), a binder (styrene-butadiene rubber (SBR)), a solvent (tetrahydronaphthalene), and copper were mixed together by using an ultrasonic homogenizer (UH-50 manufactured by SMT Co., Ltd), to obtain a positive electrode mix paste.

Here, the contents (volume ratios) of the positive electrode active material and the copper were set as indicated in Table 1. As the balance, the amounts of the conductive carbon, the solid electrolyte and the binder were adjusted appropriately such that the total amount thereof was the amount indicated in the row for “other components” in Table 1. The solvent was mixed-in in an amount such that the amount of the solvent would be 25 parts by mass when the sum of the contents of the positive electrode active material, the conductive carbon, the solid electrolyte, the binder and the copper was assumed to be 100 parts by mass.

Li₄T₅O₁₂ as the negative electrode active material was provided.

The negative electrode active material, conductive carbon, a solid electrolyte, a binder and a solvent were mixed together by using an ultrasonic homogenizer (UH-50 manufactured by SMT Co., Ltd), to obtain a negative electrode mix paste. The solid electrolyte, the binder and the solvent were the same as those used in the positive electrode mix paste.

Here, the content (volume ratio) of the negative electrode active material was set as indicated in Table 1. As the balance, the amounts of the conductive carbon, the solid electrolyte and the binder were adjusted appropriately such that the total amount thereof was the amount indicated in the row for “other components” in Table 1. The solvent was mixed-in in an amount such that the amount of the solvent would be 35 parts by mass when the sum of the contents of the negative electrode active material, the conductive carbon, the solid electrolyte and the binder was assumed to be 100 parts by mass.

51 parts by mass of a solvent, 3 parts by mass of a solution containing 5% by mass of a binder, and 46 parts by mass of LiI—LiBr—Li₂S—P₂S₅-based glass ceramic serving as a solid electrolyte were added into a container made of polypropylene, and were mixed together for 30 seconds by using an ultrasonic homogenizer (UH-50 manufactured by SMT Co., Ltd). The binder and the solvent were the same as those used in the positive electrode mix paste. Then, the container was shaken for 3 minutes by a shaker, and a solid electrolyte paste was obtained.

The positive electrode mix paste was applied to an aluminum foil by a blade method using an applicator. After application, the paste was dried for 30 minutes on a hot press of 100° C., to obtain a positive electrode sheet having a positive electrode layer on a surface of the aluminum foil.

In a similar manner, the negative electrode mix paste was applied to an aluminum foil and dried, to obtain a negative electrode sheet having a negative electrode layer.

In a similar manner, the solid electrolyte paste was applied to an aluminum foil and dried, to obtain a solid electrolyte sheet having a solid electrolyte layer. In this process, the mass per unit area of the negative electrode was adjusted such that the specific charge capacity of the negative electrode was 1× the specific charge capacity of the positive electrode layer when the specific charge capacity of the positive electrode layer was set to 200 mAh/g.

By layering the negative electrode sheet and the solid electrolyte sheet and performing pressing, the solid electrolyte layer was transferred onto the negative electrode layer surface of the negative electrode sheet.

Then, the positive electrode sheet was layered on a side of the solid electrolyte layer that was opposite to the negative electrode layer side, and roll pressing was performed at 175° C. and 5 ton/cm, thereby obtaining a layered body.

The layered body had the aluminum foil, the positive electrode layer, the solid electrolyte layer, the negative electrode layer, and the aluminum foil in this order.

The obtained layered body was laminate-sealed and restrained at 5 MPa, to obtain an all-solid-state lithium ion secondary battery.

The all-solid-state lithium ion secondary battery was left to stand still for seven days in an environment of a temperature of 80° C. This step corresponds to heat treatment of the solid-state battery.

### Examples 8 to 16

A positive electrode active material, conductive carbon, a solid electrolyte, a binder and a solvent were mixed together by using an ultrasonic homogenizer (UH-50 manufactured by SMT Co., Ltd), to obtain a positive electrode mix paste. The respective ingredients were the same as those used in Example 1.

Here, the content (volume ratio) of the positive electrode active material was set as indicated in Table 1. As the balance, the amounts of the conductive carbon, the solid electrolyte and the binder were adjusted appropriately such that the total amount thereof was the amount indicated in the row for “other components” in Table 1. The solvent was mixed-in in an amount such that the amount of the solvent would be 25 parts by mass when the sum of the contents of the positive electrode active material, the conductive carbon, the solid electrolyte and the binder was assumed to be 100 parts by mass.

A negative electrode active material, conductive carbon, a solid electrolyte, a binder, a solvent, and copper were mixed together by using an ultrasonic homogenizer (UH-50 manufactured by SMT Co., Ltd), to obtain a negative electrode mix paste. The respective ingredients were the same as those used in Example 1.

Here, the contents (volume ratios) of the negative electrode active material and the copper were set as indicated in Table 1. As the balance, the amounts of the conductive carbon, the solid electrolyte and the binder were adjusted appropriately such that the total amount thereof was the amount indicated in the row for “other components” in Table 1. The solvent was mixed-in in an amount such that the amount of the solvent would be 35 parts by mass when the sum of the contents of the negative electrode active material, the conductive carbon, the solid electrolyte, the binder and the copper was assumed to be 100 parts by mass.

An all-solid-state lithium ion secondary battery was obtained in the same manner as that in Example 1, except that the above-described positive electrode mix paste and negative electrode mix paste were used. Thereafter, the battery was left to stand still under the same conditions as those in Example 1, i.e., for seven days in an environment of a temperature of 80° C.

### Comparative Example 1

A positive electrode active material, conductive carbon, a solid electrolyte, a binder and a solvent were mixed together by using an ultrasonic homogenizer (UH-50 manufactured by SMT Co., Ltd), to obtain a positive electrode mix paste. The respective ingredients were the same as those used in Example 1.

Here, the content (volume ratio) of the positive electrode active material was set as indicated in Table 1. As the balance, the amounts of the conductive carbon, the solid electrolyte and the binder were adjusted appropriately such that the total amount thereof was the amount indicated in the row for “other components” in Table 1. The solvent was mixed-in in an amount such that the amount of the solvent would be 25 parts by mass when the sum of the contents of the positive electrode active material, the conductive carbon, the solid electrolyte and the binder was assumed to be 100 parts by mass.

An all-solid-state lithium ion secondary battery was obtained in the same manner as that in Example 1, except that the above-described positive electrode mix paste was used. Thereafter, the battery was left to stand still under the same conditions as those in Example 1, i.e., for seven days in an environment of a temperature of 80° C.

### Comparative Example 2

A negative electrode active material, conductive carbon, a solid electrolyte, a binder, a solvent and copper were mixed together by using an ultrasonic homogenizer (UH-50 manufactured by SMT Co., Ltd), to obtain a negative electrode mix paste. The respective ingredients were the same as those used in Example 1.

Here, the contents (volume ratios) of the negative electrode active material and the copper were set as indicated in Table 1. As the balance, the amounts of the conductive carbon, the solid electrolyte and the binder were adjusted appropriately such that the total amount thereof was the amount indicated in the row for “other components” in Table 1. The solvent was mixed-in in an amount such that the amount of the solvent would be 35 parts by mass when the sum of the contents of the negative electrode active material, the conductive carbon, the solid electrolyte, the binder and the copper was assumed to be 100 parts by mass.

An all-solid-state lithium ion secondary battery was obtained in the same manner as that in Example 8, except that the above-described negative electrode mix paste was used. Thereafter, the battery was left to stand still under the same conditions as those in Example 1, i.e., for seven days in an environment of a temperature of 80° C.

### <<Evaluation of Resistance>>

The obtained all-solid-state lithium ion secondary battery was placed in a thermostatic tank that was set to 25° C., and was connected to a charging/discharging device.

The battery was subjected to constant-current charging at a current corresponding to 0.1 C, and, after the cell voltage reached 2.7 V, was subjected to constant-voltage charging.

The constant-voltage charging test was ended when the current value reached a value corresponding to 0.01 C.

Next, constant-current discharging was carried out at 0.1 C until the cell voltage decreased to 2.12 V, which corresponds to SOC40, and constant-voltage discharging was carried out at 2.12 V. The constant-voltage discharging was ended at the time when the current value reached 0.01 C.

Thereafter, constant-current discharging was carried out at 72 C, and the direct current resistance was calculated from the voltage after 0.1 seconds, based on Ohm's law.

The ratios of the resistance values of the respective Examples and the respective Comparative Examples, given that the resistance value of the all-solid-state lithium ion secondary battery of Comparative Example 1 is assumed to be 100%, are shown in Table 1.

TABLE 1

| | content (based on volume) of | | | | content (based on volume) of | | | | |
|---|---|---|---|---|---|---|---|---|---|
| | respective ingredients in | | | | respective ingredients in | | | | |
| | positive electrode layer | | | | negative electrode layer | | | | |
| | positive | | | | negative | | | | |
| | electrode | | | | electrode | | | | resistance |
| | active | (other | | | active | (other | | | evaluation |
| | material | components) | copper | | material | components) | copper | | (%) |
| Example 1 | 57.0% | 43.0% | 5 | ppm | 62.5% | 37.5% | — | | 97.97 |
| Example 2 | 57.0% | 43.0% | 20 | ppm | 62.5% | 37.5% | — | | 95.22 |
| Example 3 | 57.0% | 43.0% | 100 | ppm | 62.5% | 37.5% | — | | 93.59 |
| Example 4 | 57.0% | 43.0% | 500 | ppm | 62.5% | 37.5% | — | | 87.24 |
| Example 5 | 56.9% | 43.0% | 1,000 | ppm | 62.5% | 37.5% | — | | 81.39 |
| Example 6 | 56.9% | 42.9% | 2,000 | ppm | 62.5% | 37.5% | — | | 80.84 |
| Example 7 | 56.7% | 42.8% | 5,000 | ppm | 62.5% | 37.5% | — | | 85.56 |
| Example 8 | 57.0% | 43.0% | — | | 62.5% | 37.5% | 5 | ppm | 90.53 |
| Example 9 | 57.0% | 43.0% | — | | 62.5% | 37.5% | 20 | ppm | 88.16 |
| Example 10 | 57.0% | 43.0% | — | | 62.5% | 37.5% | 50 | ppm | 84.21 |
| Example 11 | 57.0% | 43.0% | — | | 62.5% | 37.5% | 100 | ppm | 82.99 |
| Example 12 | 57.0% | 43.0% | — | | 62.4% | 37.5% | 250 | ppm | 81.66 |
| Example 13 | 57.0% | 43.0% | — | | 62.4% | 37.5% | 500 | ppm | 79.44 |
| Example 14 | 57.0% | 43.0% | — | | 62.4% | 37.5% | 1,000 | ppm | 78.87 |
| Example 15 | 57.0% | 43.0% | — | | 62.3% | 37.5% | 2,000 | ppm | 81.55 |
| Example 16 | 57.0% | 43.0% | — | | 62.1% | 37.4% | 5,000 | ppm | 82.12 |
| Comparative | 57.0% | 43.0% | — | | 62.5% | 37.5% | — | | 100 |
| Example 1 | | | | | | | | | |
| Comparative | 57.0% | 43.0% | — | | 61.8% | 37.2% | 10,000 | ppm | 111.9 |
| Example 2 | | | | | | | | | |

From the results of Table 1, it can be seen that the solid-state batteries of the Examples, in which the content of the metal (copper) with respect to the total volume of the electrode for a solid-state battery is greater than or equal to 5 ppm by volume, exhibited a lower resistance after heat treatment and thus a reduction in increase of the resistance as compared with the solid-state battery of Comparative Example 1, which does not contain the metal. Further, it can be seen that the solid-state batteries of the Examples, in which the content of the metal (copper) with respect to the total volume of the electrode for a solid-state battery is less than 10,000 ppm by volume, exhibited a lower resistance after heat treatment and thus a reduction in increase of the resistance as compared with the solid-state battery of Comparative Example 2, in which the content of the metal (copper) is an amount exceeding this range.

Note that details of the test for confirming that copper is a metal that reacts with a sulfide solid electrolyte to exhibit electron conductivity, are described later.

### Examples 17 to 20, and Comparative Examples 3 and 4

A negative electrode active material, conductive carbon, a solid electrolyte, a binder, a solvent and silver were mixed together by using an ultrasonic homogenizer (UH-50 manufactured by SMT Co., Ltd), to obtain a negative electrode mix paste. The respective ingredients were the same as those used in Example 1.

Here, the contents (volume ratios) of the negative electrode active material and the silver were set as indicated in Table 2. As the balance, the amounts of the conductive carbon, the solid electrolyte and the binder were adjusted appropriately such that the total amount thereof was the amount indicated in the row for “other components” in Table 2. The solvent was mixed-in in an amount such that the amount of the solvent would be 35 parts by mass when the sum of the contents of the negative electrode active material, the conductive carbon, the solid electrolyte, the binder and the silver was assumed to be 100 parts by mass.

An all-solid-state lithium ion secondary battery was obtained in the same manner as that in Example 8, except that the above-described negative electrode mix paste was used. Thereafter, the battery was left to stand still under the same conditions as those in Example 1, i.e., for seven days in an environment of a temperature of 80° C.

### <<Evaluation of Resistance>>

Evaluation of the resistance of the obtained all-solid-state lithium ion secondary battery was carried out in the same manner as that in Example 1.

The ratios of the resistance values of the respective Examples and the respective Comparative Examples, given that the resistance value of the all-solid-state lithium ion secondary battery of Comparative Example 1 is assumed to be 100%, are shown in Table 2.

TABLE 2

| | content (based on volume) of | | | content (based on volume) | | | | |
|---|---|---|---|---|---|---|---|---|
| | respective ingredients in | | | of respective ingredients | | | | |
| | positive electrode layer | | | in negative electrode layer | | | | |
| | positive | | | negative | | | | |
| | electrode | | | electrode | | | | resistance |
| | active | (other | | active | (other | | | evaluation |
| | material | components) | silver | material | components) | silver | | (%) |
| Example 17 | 57.0% | 43.0% | — | 62.5% | 37.5% | 5 | ppm | 98.49 |
| Example 18 | 57.0% | 43.0% | — | 62.5% | 37.5% | 100 | ppm | 84.75 |
| Example 19 | 57.0% | 43.0% | — | 62.3% | 37.5% | 2,000 | ppm | 87.48 |
| Example 20 | 57.0% | 43.0% | — | 62.1% | 37.4% | 5,000 | ppm | 88.48 |
| Comparative | 57.0% | 43.0% | — | 61.8% | 37.2% | 10,000 | ppm | 108.81 |
| Example 3 | | | | | | | | |
| Comparative | 57.0% | 43.0% | — | 61.2% | 36.8% | 20,000 | ppm | 126.48 |
| Example 4 | | | | | | | | |

From the results of Table 2, it can be seen that the solid-state batteries of the Examples, in which the content of the metal (silver) with respect to the total volume of the electrode for a solid-state battery is greater than or equal to 5 ppm by volume and less than 10,000 ppm by volume, exhibited a lower resistance after heat treatment and thus a reduction in increase of the resistance as compared with the solid-state batteries of the Comparative Examples, in which the metal (silver) was contained in an amount of greater than or equal to 10,000 ppm by volume.

Note that details of the test for confirming that silver is a metal that reacts with a sulfide solid electrolyte to exhibit electron conductivity, are described later.

### Comparative Examples 5 to 8

A negative electrode active material, conductive carbon, a solid electrolyte, a binder, a solvent and stainless SUS 316 were mixed together by using an ultrasonic homogenizer (UH-50 manufactured by SMT Co., Ltd), to obtain a negative electrode mix paste. The respective ingredients were the same as those used in Example 1.

Here, the contents (volume ratios) of the negative electrode active material and the stainless SUS 316 were set as indicated in Table 3. As the balance, the amounts of the conductive carbon, the solid electrolyte and the binder were adjusted appropriately such that the total amount thereof was the amount indicated in the row for “other components” in Table 3. The solvent was mixed-in in an amount such that the amount of the solvent would be 35 parts by mass when the sum of the contents of the negative electrode active material, the conductive carbon, the solid electrolyte, the binder and the stainless SUS 316 was assumed to be 100 parts by mass.

An all-solid-state lithium ion secondary battery was obtained in the same manner as that in Example 8, except that the above-described negative electrode mix paste was used. Thereafter, the battery was left to stand still under the same conditions as those in Example 1, i.e., for seven days in an environment of a temperature of 80° C.

### <<Evaluation of Resistance>>

Evaluation of the resistance of the obtained all-solid-state lithium ion secondary battery was carried out in the same manner as that in Example 1.

The ratios of the resistance values of the respective Comparative Examples, given that the resistance value of the all-solid-state lithium ion secondary battery of Comparative Example 1 is assumed to be 100%, are shown in Table 3.

TABLE 3

| | content (based on volume) of | | | content (based on volume) of | | | | |
|---|---|---|---|---|---|---|---|---|
| | respective ingredients in | | | respective ingredients in | | | | |
| | positive electrode layer | | | negative electrode layer | | | | |
| | positive | | | negative | | | | |
| | electrode | | | electrode | | | | resistance |
| | active | (other | stainless | active | (other | stainless | | evaluation |
| | material | components) | SUS 316 | material | components) | SUS 316 | | (%) |
| Comparative | 57.0% | 43.0% | — | 62.5% | 37.5% | 100 | ppm | 102.17 |
| Example 5 | | | | | | | | |
| Comparative | 57.0% | 43.0% | — | 62.4% | 37.5% | 500 | ppm | 103.82 |
| Example 6 | | | | | | | | |
| Comparative | 57.0% | 43.0% | — | 62.4% | 37.5% | 1,000 | ppm | 112.27 |
| Example 7 | | | | | | | | |
| Comparative | 57.0% | 43.0% | — | 62.3% | 37.5% | 2,000 | ppm | 116.76 |
| Example 8 | | | | | | | | |

From the results of Table 3, it can be seen that the solid-state batteries of the Comparative Examples, in which stainless SUS 316 was contained in the electrode for a solid-state battery, exhibited a high resistance after heat treatment and did not exhibit reduction in the increase of the resistance.

Note that details of the test for confirming that stainless SUS 316 is not a metal that reacts with a sulfide solid electrolyte to exhibit electron conductivity, are described later.

### Comparative Examples 9 to 10

A positive electrode active material, conductive carbon, a solid electrolyte, a binder, a solvent and copper were mixed together by using an ultrasonic homogenizer (UH-50 manufactured by SMT Co., Ltd), to obtain a positive electrode mix paste. The respective ingredients were the same as those used in Example 1.

Here, the contents (volume ratios) of the positive electrode active material and the copper were set as indicated in Table 4. As the balance, the amounts of the conductive carbon, the solid electrolyte and the binder were adjusted appropriately such that the total amount thereof was the amount indicated in the row for “other components” in Table 4. The solvent was mixed-in in an amount such that the amount of the solvent would be 25 parts by mass when the sum of the contents of the positive electrode active material, the conductive carbon, the solid electrolyte, the binder and the copper was assumed to be 100 parts by mass.

An all-solid-state lithium ion secondary battery was obtained in the same manner as that in Example 1, except that the above-described positive electrode mix paste was used. Thereafter, the battery was left to stand still under the same conditions as those in Example 1, i.e., for seven days in an environment of a temperature of 80° C.

### Comparative Example 11

A negative electrode active material, conductive carbon, a solid electrolyte, a binder, a solvent and copper were mixed together by using an ultrasonic homogenizer (UH-50 manufactured by SMT Co., Ltd), to obtain a negative electrode mix paste. The respective ingredients were the same as those used in Example 1.

Here, the contents (volume ratios) of the negative electrode active material and the copper were set as indicated in Table 4. As the balance, the amounts of the conductive carbon, the solid electrolyte and the binder were adjusted appropriately such that the total amount thereof was the amount indicated in the row for “other components” in Table 4. The solvent was mixed-in in an amount such that the amount of the solvent would be 35 parts by mass when the sum of the contents of the negative electrode active material, the conductive carbon, the solid electrolyte, the binder and the copper was assumed to be 100 parts by mass.

An all-solid-state lithium ion secondary battery was obtained in the same manner as that in Example 1, except that the above-described negative electrode mix paste was used. Thereafter, the battery was left to stand still under the same conditions as those in Example 1, i.e., for seven days in an environment of a temperature of 80° C.

### <<Evaluation of Reduction of Short-Circuiting (Evaluation of Self-Discharge Amount)>>

The obtained all-solid-state lithium ion secondary battery was placed in a thermostatic tank that was set to 25° C., and was connected to a charging/discharging device.

Constant-voltage charging at 2.515 V was carried out. The constant voltage charging was ended when the current value decreased to 0.01 C. Thereafter, the battery voltage was measured in terms of open circuit voltage for 72 hours. The amount of the decrease in the voltage in the 24-hour time period from 48 hours to 72 hours was calculated as the self-discharge amount.

Measuring of the above-described self-discharge amount was carried out on the batteries of Examples 3 to 7, Examples 11 to 16, Comparative Examples 1,2, and 9 to 11. Results thereof are collectively shown in Table 4.

TABLE 4

| | | | | | | | | | short- |
|---|---|---|---|---|---|---|---|---|---|
| | | | | | | | | | circuiting |
| | content (based on volume) of | | | | content (based on volume) of | | | | reduction |
| | respective ingredients in | | | | respective ingredients in | | | | evaluation |
| | positive electrode layer | | | | negative electrode layer | | | | (self- |
| | positive | | | | negative | | | | discharge |
| | electrode | | | | electrode | | | | amount |
| | active | (other | | | active | (other | | | evaluation) |
| | material | components) | copper | | material | components) | copper | | [mV/day] |
| Example 3 | 57.0% | 43.0% | 100 | ppm | 62.5% | 37.5% | — | | 2.17 |
| Example 4 | 57.0% | 43.0% | 500 | ppm | 62.5% | 37.5% | — | | 2.28 |
| Example 5 | 56.9% | 43.0% | 1,000 | ppm | 62.5% | 37.5% | — | | 3.54 |
| Example 6 | 56.9% | 42.9% | 2,000 | ppm | 62.5% | 37.5% | — | | 4.31 |
| Example 7 | 56.7% | 42.8% | 5,000 | ppm | 62.5% | 37.5% | — | | 9.05 |
| Example 11 | 57.0% | 43.0% | — | | 62.5% | 37.5% | 100 | ppm | 2.50 |
| Example 12 | 57.0% | 43.0% | — | | 62.4% | 37.5% | 250 | ppm | 2.50 |
| Example 13 | 57.0% | 43.0% | — | | 62.4% | 37.5% | 500 | ppm | 2.63 |
| Example 14 | 57.0% | 43.0% | — | | 62.4% | 37.5% | 1,000 | ppm | 2.75 |
| Example 15 | 57.0% | 43.0% | — | | 62.3% | 37.5% | 2,000 | ppm | 27.63 |
| Example 16 | 57.0% | 43.0% | — | | 62.1% | 37.4% | 5,000 | ppm | 61.00 |
| Comparative | 57.0% | 43.0% | — | | 62.5% | 37.5% | — | | 2.20 |
| Example 1 | | | | | | | | | |
| Comparative | 56.4% | 42.6% | 10,000 | ppm | 62.5% | 37.5% | — | | 67.80 |
| Example 9 | | | | | | | | | |
| Comparative | 55.9% | 42.1% | 20,000 | ppm | 62.5% | 37.5% | — | | 508.50 |
| Example 10 | | | | | | | | | |
| Comparative | 57.0% | 43.0% | — | | 61.8% | 37.2% | 10,000 | ppm | 60.25 |
| Example 2 | | | | | | | | | |
| Comparative | 57.0% | 43.0% | — | | 61.2% | 36.8% | 20,000 | ppm | 564.55 |
| Example 11 | | | | | | | | | |

From the results of Table 4, it can be seen that the solid-state batteries of Examples 3 to 6 and Examples 11 to 15, in which the content of the metal (copper) with respect to the total volume of the electrode for a solid-state battery was less than or equal to 4,000 ppm by volume, exhibited a small self-discharge amount and improvement in reduction of short-circuiting, as compared with the solid-state batteries of Examples 7, 16 and the Comparative Examples, in which the metal (copper) was contained in an amount exceeding 4,000 ppm by volume.

### Examples 21 to 25

A positive electrode active material, conductive carbon, a solid electrolyte, a binder, a solvent and copper were mixed together by using an ultrasonic homogenizer (UH-50 manufactured by SMT Co., Ltd), to obtain a positive electrode mix paste. The respective ingredients were the same as those used in Example 1.

Here, the contents (volume ratios) of the positive electrode active material and the copper were set as indicated in Table 5. As the balance, the amounts of the conductive carbon, the solid electrolyte and the binder were adjusted appropriately such that the total amount thereof was the amount indicated in the row for “other components” in Table 5. The solvent was mixed-in in an amount such that the amount of the solvent would be 25 parts by mass when the sum of the contents of the positive electrode active material, the conductive carbon, the solid electrolyte, the binder and the copper was assumed to be 100 parts by mass.

A negative electrode active material, conductive carbon, a solid electrolyte, a binder, a solvent, and copper were mixed together by using an ultrasonic homogenizer (UH-50 manufactured by SMT Co., Ltd), to obtain a negative electrode mix paste. The respective ingredients were the same as those used in Example 1.

Here, the contents (volume ratios) of the negative electrode active material and the copper were set as indicated in Table 5. As the balance, the amounts of the conductive carbon, the solid electrolyte and the binder were adjusted appropriately such that the total amount thereof was the amount indicated in the row for “other components” in Table 5. The solvent was mixed-in in an amount such that the amount of the solvent would be 35 parts by mass when the sum of the contents of the negative electrode active material, the conductive carbon, the solid electrolyte, the binder and the copper was assumed to be 100 parts by mass.

An all-solid-state lithium ion secondary battery was obtained in the same manner as that in Example 1, except that the above-described positive electrode mix paste and negative electrode mix paste were used. Thereafter, the battery was left to stand still under the same conditions as those in Example 1, i.e., for seven days in an environment of a temperature of 80° C.

### <<Evaluation of Resistance>>

Evaluation of the resistance of the obtained all-solid-state lithium ion secondary battery was carried out in the same manner as that in Example 1.

The ratios of the resistance values of the respective Examples, given that the resistance value of the all-solid-state lithium ion secondary battery of Comparative Example 1 is assumed to be 100%, are shown in Table 5.

### <<Evaluation of Reduction of Short-Circuiting (Evaluation of Self-Discharge Amount)>>

Evaluation of reduction short-circuiting of the obtained all-solid-state lithium ion secondary battery was carried out in the same manner as that in Example 1. The results of the self-discharge amounts are shown in Table 5.

TABLE 5

| | | | | | | | | | | short- |
|---|---|---|---|---|---|---|---|---|---|---|
| | | | | | | | | | | circuiting |
| | content (based on volume) of | | | | content (based on volume) of | | | | | reduction |
| | respective ingredients in | | | | respective ingredients in | | | | | evaluation |
| | positive electrode layer | | | | negative electrode layer | | | | | (self- |
| | positive | | | | negative | | | | | discharge |
| | electrode | | | | electrode | | | | resistance | amount |
| | active | (other | | | active | (other | | | evaluation | evaluation) |
| | material | components) | copper | | material | components) | copper | | (%) | [mV/day] |
| Example | 57.0% | 43.0% | 50 | ppm | 62.5% | 37.5% | 50 | ppm | 89.70 | 2.28 |
| 21 | | | | | | | | | | |
| Example | 57.0% | 43.0% | 100 | ppm | 62.5% | 37.5% | 100 | ppm | 86.93 | 2.80 |
| 22 | | | | | | | | | | |
| Example | 57.0% | 43.0% | 200 | ppm | 62.4% | 37.5% | 200 | ppm | 80.63 | 2.53 |
| 23 | | | | | | | | | | |
| Example | 57.0% | 43.0% | 500 | ppm | 62.4% | 37.5% | 500 | ppm | 82.10 | 2.07 |
| 24 | | | | | | | | | | |
| Example | 56.9% | 43.0% | 1,000 | ppm | 62.4% | 37.5% | 1,000 | ppm | 84.10 | 2.25 |
| 25 | | | | | | | | | | |

### <<Verifying Whether Metal is the Specific Metal>>

In accordance with the above-described verification method, it was determined whether or not each of copper, silver, and stainless SUS 316, which were used in the above-described Examples, as well as nickel, aluminum, gold, iron, platinum and zinc, which were not used in the above-described Examples, is a metal that reacts with a sulfide solid electrolyte to exhibit electron conductivity (i.e., is the specific metal). The results with respect to the measured rate of increase in the electron conductance during the heat treatment are shown in Table 6.

TABLE 6

| | | electron | rate of increase |
|---|---|---|---|
| | initial | conductance | in electron |
| | electron | after heat | conductance |
| | conductance | treatment | during heat |
| Metal Species | [S/cm] | [S/cm] | treatment |
| Silver | 2.09E−08 | 1.15E−07 | 5.50 |
| Nickel | 3.70E−09 | 2.58E−03 | 695984.53 |
| SUS316 | 2.08E−09 | 4.39E−09 | 2.11 |
| Copper | 1.67E−08 | 4.27E−04 | 25583.58 |
| Aluminum | 1.62E−09 | 4.05E−09 | 2.50 |
| Gold | 5.58E−09 | 1.45E−08 | 2.60 |
| Iron | 3.31E−09 | 1.67E−07 | 50.50 |
| Platinum | 1.64E−09 | 4.28E−09 | 2.60 |
| Zinc | 4.50E−09 | 9.77E−09 | 2.17 |

In FIG. 1, the reference characters respectively represent the following elements.
A: negative electrode layer
B: solid electrolyte layer
C: positive electrode layer
101: negative electrode active material
103: positive electrode active material
105 and 107: conductive aid
109 and 111: binder
113: negative electrode current collector
115: positive electrode current collector

What is claimed is:

1. An electrode for a solid-state battery, comprising:
a sulfide solid electrolyte; and
a metal that reacts with the sulfide solid electrolyte to exhibit electron conductivity,
wherein a content of the metal, with respect to a total volume of the electrode for a solid-state battery, is greater than or equal to 5 ppm by volume and less than 10,000 ppm by volume.

2. The electrode for a solid-state battery according to claim 1, wherein the metal is at least one metal selected from the group consisting of copper, silver, nickel, iron, tin, aluminum, titanium, chromium, zinc, gold, magnesium, antimony, zirconium, molybdenum, and alloys thereof.

3. The electrode for a solid-state battery according to claim 2, wherein the metal is at least one of copper or silver.

4. The electrode for a solid-state battery according to claim 1, wherein the content of the metal, with respect to the total volume of the electrode for a solid-state battery, is greater than or equal to 50 ppm by volume.

5. The electrode for a solid-state battery according to claim 1, wherein the content of the metal, with respect to the total volume of the electrode for a solid-state battery, is less than or equal to 5,000 ppm by volume.

6. The electrode for a solid-state battery according to claim 1, wherein the sulfide solid electrolyte contains a phosphorus atom.

7. A solid-state battery, comprising a positive electrode layer, a solid electrolyte layer, and a negative electrode layer,
wherein at least one of the positive electrode layer or the negative electrode layer is the electrode for a solid-state battery according to claim 1.
